(19) United States
(12) Patent Application Publication
(10) Pub. No.: US 2018/0068659 A1
(43) Pub. Date: Mar. 8, 2018

(54) VOICE RECOGNITION DEVICE AND VOICE RECOGNITION METHOD

(71) Applicant: TOYOTA JIDOSHA KABUSHIKI KAISHA, Toyota-shi (JP)

(72) Inventors: Atsushi IKENO, Kyoto-shi (JP); Muneaki SHIMADA, Tokyo (JP); Kota HATANAKA, Kama-shi (JP); Toshifumi NISHIJIMA, Kasugai-shi (JP); Fuminori KATAOKA, Nisshin-shi (JP); Hiromi TONEGAWA, Okazaki-shi (JP); Norihide UMEYAMA, Nisshin-shi (JP)

(73) Assignee: TOYOTA JIDOSHA KABUSHIKI KAISHA, Toyota-shi (JP)

(21) Appl. No.: 15/692,633

(22) Filed: Aug. 31, 2017

(30) Foreign Application Priority Data
Sep. 6, 2016 (JP) 2016-173902

(51) Int. Cl. G10L 15/22; G10L 15/30; G06F 17/27; G10L 15/01

(52) U.S. Cl. CPC G10L 15/22; G10L 15/30; G10L 2015/226; G10L 15/01; G10L 2015/225; G06F 17/2735

(57) ABSTRACT

A voice recognition device comprises a voice acquisition unit that acquires voice given by a user; a voice recognition unit that recognizes the acquired voice to acquire a voice recognition result; a category classification unit that classifies a speech content of the user into a category, based on the voice recognition result; an information acquisition unit that acquires a category dictionary including words corresponding to the classified category; and a correction unit that corrects the voice recognition result, based on the category dictionary.

### BACKGROUND OF THE INVENTION

### Field of the Invention

The present invention relates to a voice recognition device that recognizes input voice.

Description of the Related Art

Voice recognition technologies to recognize voice given by users and cause computers to perform processing using recognition results have become widespread. The use of the voice recognition technologies makes it possible to operate computers in a non-contact state, and particularly greatly improves the convenience of computers mounted in movable bodies such as automobiles.

Recognition accuracy in performing voice recognition is different depending on the scales of dictionaries used in the recognition. For example, there could be a significant difference in the recognition accuracy between a workstation dedicated to voice recognition and a personal computer not dedicated to the voice recognition.

In view of this, there has been employed a method in which voice data is transferred to a large-scale computer via a communication line to acquire a recognition result when the use of voice recognition is desired in a small-scale computer.

### SUMMARY OF THE INVENTION

Since voice recognition is performed based on a result obtained when input voice and a recognition dictionary are compared with each other, a different word similar in pronunciation and feature could be output as a recognition result.

The present invention has been made in consideration of the above problems and has an object of improving accuracy in voice recognition performed by a voice recognition device.

The present invention in its one aspect provides a voice recognition device comprising a voice acquisition unit that acquires voice given by a user; a voice recognition unit that recognizes the acquired voice to acquire a voice recognition result; a category classification unit that classifies a speech content of the user into a category, based on the voice recognition result; an information acquisition unit that acquires a category dictionary including words corresponding to the classified category; and a correction unit that corrects the voice recognition result, based on the category dictionary.

In order to prevent a false word from being recognized, the voice recognition device according to the present invention performs voice recognition in combination with features other than acoustic features.

The category classification unit is a unit that classifies a speech content given by a user into a category based on a voice recognition result. Thus, it becomes possible to acquire the category of a target about which the user talks. A category may be selected from among a plurality of categories defined in advance such as a “location,” a “person,” and “food.”

The information acquisition unit is a unit that acquires a category dictionary including words corresponding to a classified category. A category dictionary may be generated in advance for each category or may be dynamically collected according to a category. For example, a category dictionary may be information collected using external information sources such as web services.

Further, the correction unit is a unit that corrects a voice recognition result based on a category dictionary. For example, when it is determined that a user has talked about a location, the correction unit corrects a voice recognition result using a category dictionary (including, for example, abundant proper nouns) corresponding to the location.

Since it becomes possible to distinguish words acoustically similar to each other based on a category according to the configuration, accuracy in voice recognition is improved.

The category dictionary may include the words corresponding to the category and relevant to the user, and the correction unit may replace a word included in the voice recognition result with one of the words included in the category dictionary when the word included in the category dictionary and the word included in the voice recognition result are similar to each other.

For example, words relevant to a user include, but not limited to, words relevant to user's location information, user's movement paths, user's preferences, user's friendships, or the like.

For example, words corresponding to a category “location” and relevant to a user include the names of landmarks existing near the current location of the user or the like.

Further, the similarity between words means that the words are acoustically similar to each other. According to the configuration, it becomes possible to offer a correction candidate suitable for a user using a device.

The voice recognition device may further comprise a location information acquisition unit that acquires location information, and the information acquisition unit may acquire information on a name of a landmark relevant to the location information as the category dictionary, and the correction unit may correct the voice recognition result using the information on the name of the landmark when the speech content of the user is relevant to a location.

When the speech content of a user is relevant to a location, the information acquisition unit acquires information on the name of a landmark based on location information. Location information may be information indicating a current location, path information to a destination, or the like. Note that a device different from a device that performs voice recognition may acquire information. According to the configuration, it becomes possible to improve accuracy in recognizing proper nouns relevant to landmarks.

The information acquisition unit may acquire the information on the name of the landmark existing near a location indicated by the location information.

This is because a user is highly likely to mention a landmark existing near a location indicated by location information.

The voice recognition device may further comprise a path acquisition unit that acquires information on a movement path of the user, and the information acquisition unit may acquire the information on the name of the landmark existing near the movement path of the user.

When the acquisition of the movement path of a user is allowed, the information acquisition unit acquires information on the name of a landmark existing near the movement path. Since a user is highly likely to mention a landmark existing near a movement path, accuracy in recognizing a proper noun relevant to the landmark may be further improved. Note that a user's movement path may be acquired from a navigation device or a mobile terminal owned by a user. Further, a movement path may be a path ranging from the place of departure to a current location or a path ranging from a current location to a destination. Further, a movement path may be a path from the place of departure to a destination.

The information acquisition unit may acquire information on a preference of the user as the category dictionary, and the correction unit may correct the voice recognition result using the information on the preference of the user when the speech content of the user is relevant to the preference of the user.

For example, the preference of a user includes, but not limited to, the genres of information that the user cares about such as food, hobbies, TV shows, sports, web sites, and music.

Information on the preference of a user may be stored in a voice recognition device or may be acquired from an external device (for example, a mobile terminal owned by the user). Further, information on the preference of a user may be acquired based on profile information generated in advance or may be dynamically generated based on the viewing records of web sites, the playback records of music and movies, or the like.

The information acquisition unit may acquire information on registered contact addresses from a mobile terminal owned by the user as the category dictionary, and the correction unit may correct the voice recognition result using the information on the contact addresses when the speech content of the user is relevant to a person.

According to the configuration, accuracy in recognizing proper nouns relevant to acquaintances of a user may be further improved.

The voice recognition unit may perform voice recognition via a voice recognition server.

In general, user-specific information may not be reflected when a server is caused to perform voice recognition, and recognition accuracy may not be assured when voice recognition is locally performed. In the present invention, however, a recognition result is corrected using information on a user after a server performs voice recognition. Therefore, both the reflection of user-specific information and the assurance of recognition accuracy may be achieved.

Note that the present invention may be specified as a voice recognition device including at least some of the above units. Further, the present invention may be specified as a voice recognition method performed by the voice recognition device. The above processing and units may be freely combined together to be carried out unless technological contradictions arise.

According to an embodiment of the present invention, it is possible to improve accuracy in voice recognition performed by a voice recognition device.

### BRIEF DESCRIPTION OF THE DRAWINGS

FIG. 1 is a system configuration diagram of a dialogue system according to a first embodiment;

FIG. 2 is a flowchart diagram of processing performed by an in-vehicle terminal according to the first embodiment;

FIG. 3 is a flowchart diagram of the processing performed by the in-vehicle terminal according to the first embodiment;

FIG. 4 is a system configuration diagram of a dialogue system according to a second embodiment; and

FIG. 5 is a flowchart diagram of processing performed by the dialogue system according to the second embodiment.

### DESCRIPTION OF THE EMBODIMENTS

### First Embodiment

Hereinafter, preferred embodiments of the present invention will be described with reference to the drawings.

A dialogue system according to a first embodiment is a system that acquires a voice command from a user (for example, a driver) riding on a vehicle to perform voice recognition, generates a response text based on a recognition result, and offers the generated response text to the user.

<System Configuration>

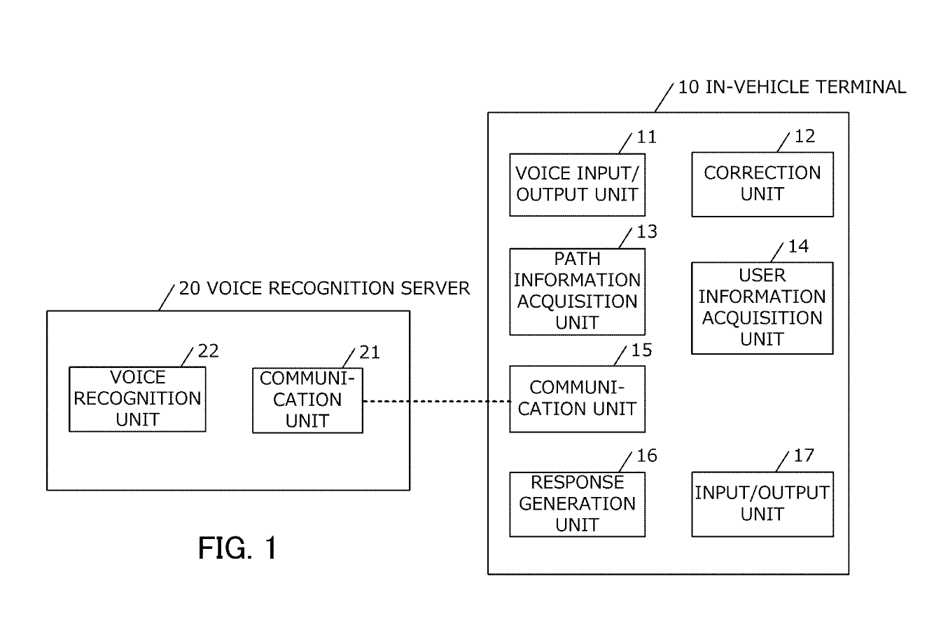

FIG. 1 is a system configuration diagram of the dialogue system according to the first embodiment.

The dialogue system according to the embodiment is composed of an in-vehicle terminal 10 and a voice recognition server 20.

The in-vehicle terminal 10 is a device that has the function of acquiring voice given by a user to perform voice recognition via the voice recognition server 20 and the function of generating a response text based on a voice recognition result and offering the generated response text to the user. The in-vehicle terminal 10 may be, for example, an in-vehicle car navigation device or a general-purpose computer. Further, the in-vehicle terminal 10 may be another in-vehicle device.

Further, the voice recognition server 20 is an apparatus that performs voice recognition processing on voice data transmitted from the in-vehicle terminal 10 and converts the voice data into a text. The detailed configuration of the voice recognition server 20 will be described later.

The in-vehicle terminal 10 is composed of a voice input/output unit 11, a correction unit 12, a path information acquisition unit 13, a user information acquisition unit 14, a communication unit 15, a response generation unit 16, and an input/output unit 17.

The voice input/output unit 11 is a unit that inputs/outputs voice. Specifically, the voice input/output unit 11 converts voice into an electric signal (hereinafter called voice data) using a microphone not shown. The acquired voice data is transmitted to the voice recognition server 20 that will be described later. Further, the voice input/output unit 11 converts voice data transmitted from the response generation unit 16 that will be described later into voice using a speaker not shown.

The correction unit 12 is a unit that corrects a result obtained when the voice recognition server 20 performs voice recognition. The correction unit 12 performs (1) processing to classify a speech content given by a user into a category based on a text acquired from the voice recognition server 20 and (2) processing to correct a voice recognition result based on the classified category and path information and user information that will be described later. A specific correction method will be described later.

The path information acquisition unit 13 is a unit that acquires information on a user's movement path (path information) and corresponds to a path acquisition unit in the present invention. The path information acquisition unit 13 acquires a current location, a destination, and path information to a destination from a device having a path guiding function such as a navigation device mounted in a vehicle and a mobile terminal.

The user information acquisition unit 14 is a unit that acquires information on a device user (user information). In the embodiment, the user information acquisition unit 14 specifically acquires the three types of information items, i.e., (1) name information registered in the contact addresses of a user, (2) profile information on the user, and (3) music playback records from a mobile terminal owned by the user.

The communication unit 15 is a unit that accesses a network via a communication line (for example, a mobile telephone network) to perform communication with the voice recognition server 20.

The response generation unit 16 is a unit that generates a text (speech text) as a response to a user based on a text transmitted from the voice recognition server 20 (i.e., a speech content given by the user). The response generation unit 16 may generate a response based on, for example, a dialogue scenario (dialogue dictionary) stored in advance. The response generated by the response generation unit 16 is transmitted to the input/output unit 17 that will be described later in a text form and then output to a user as synthetic voice.

The voice recognition server 20 is a server apparatus dedicated to voice recognition and composed of a communication unit 21 and a voice recognition unit 22.

Since the function of the communication unit 21 is the same as that of the communication unit 15 described above, its detailed description will be omitted.

The voice recognition unit 22 is a unit that performs voice recognition on acquired voice data and converts the voice data into a text. The voice recognition may be performed according to a known technology. The voice recognition unit 22 stores, for example, an acoustic model and a recognition dictionary. The voice recognition unit 22 compares acquired voice data with the acoustic model to extract features and matches the extracted features to the recognition dictionary to perform the voice recognition. A text obtained as a result of the voice recognition is transmitted to the in-vehicle terminal 10.

Each of the in-vehicle terminal 10 and the voice recognition server 20 may be configured as an information processor having a CPU, a main storage unit, and an auxiliary storage unit. Each of the units shown in FIG. 1 functions when a program stored in the auxiliary storage unit is loaded into the main storage unit and performed by the CPU. Note that all or some of the functions shown in FIG. 1 may be performed using an exclusively-designed circuit.

<Processing Flowchart>

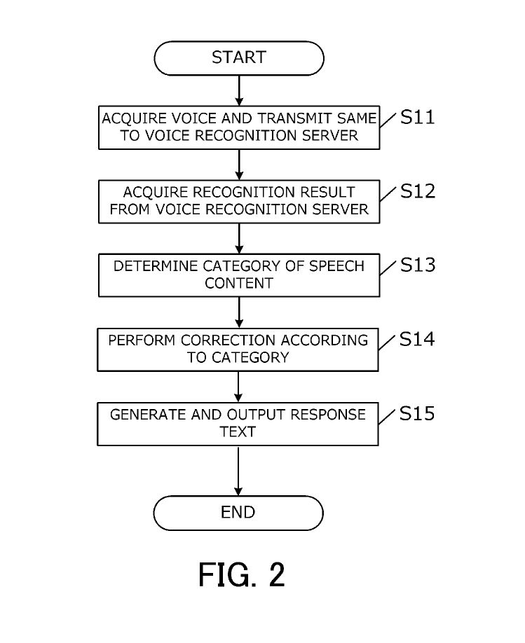

Next, the content of specific processing performed by the in-vehicle terminal 10 will be described. FIG. 2 is a flowchart showing the processing performed by the in-vehicle terminal 10.

First, in step S11, the voice input/output unit 11 acquires voice from a user via a microphone not shown. The acquired voice is converted into voice data and transmitted to the voice recognition server 20 via the communication units 15 and 21.

The transmitted voice data is converted into a text by the voice recognition unit 22, and the converted voice data is transmitted to the correction unit 12 via the communication units 21 and 15 (step S12).

Then, in step S13, the correction unit 12 determines the category of a speech content.

The category of the speech content may be determined based on, for example, the matching degree of words. The correction unit 12 parses the text into words based on, for example, a morphological analysis and verifies whether words other than postpositional words, adverbs, or the like match prescribed words set for each category. Then, the correction unit 12 adds a score set for each word together to calculate a total score for each category. Finally, the correction unit 12 determines a category having the highest score as the category of the speech content.

Note that the correction unit 12 determines the category of the speech content based on the matching degree of the words in this example, but the category of the speech content may be determined using a method such as machine learning.

Next, in step S14, the correction unit 12 corrects the text of the recognition result according to the determined category.

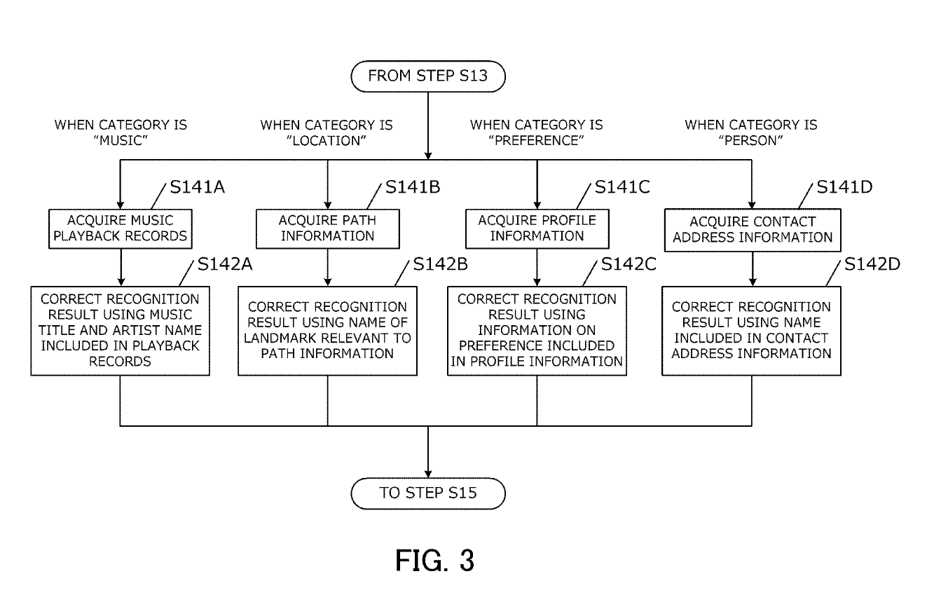

Here, processing performed by the correction unit 12 in step S14 will be more specifically described with reference to FIG. 3. In the embodiment, it is assumed that the speech content is classified into the four types of categories “music,” a “location,” a “preference,” and a “person.”

First, an example of a case in which the category of the speech content is the “music” will be described.

When the category of the speech content is the “music” (step S141A), the correction unit 12 acquires music playback records from a mobile terminal owned by the user via the user information acquisition unit 14 and corrects the recognition result using a music title and an artist name included in the playback records (step S142A).

For example, it is assumed that the recognition result output from the voice recognition server 20 is “Will a new piece of music be released by Beads?” and the category of the speech content is determined to be the “music” based on the word “a new piece of music.” In this case, the correction unit 12 determines that the word “B'z” included in the playback records and the word “Beads” included in the recognition result are acoustically similar to each other, and thus performs a correction to convert “Beads” into “B'z” (here, B'z is a Japanese musical group).

After that, in step S15, the response generation unit 16 generates a response based on the text “Will a new piece of music be released by B'z?” The response generation unit 16 searches for, for example, web services or the like to acquire a release schedule for a new album and offers the acquired release schedule to the user.

Next, an example of a case in which the category of the speech content is the “location.”

When the category of the speech content is the “location” (step S141B), the correction unit 12 acquires path information via the path information acquisition unit 13, acquires the name of a landmark existing along the path, and corrects the recognition result using the name of the landmark (step S142B).

Here, consideration is given to a case in which the user talks about “Akasaka Sacas” the name of a complex facility in Tokyo.

For example, it is assumed that the recognition result output from the voice recognition server 20 is “Is Akasaka Circus around here?” and the category of the speech content is determined to be the “location” based on the word “around here.” In this case, the correction unit 12 determines that the name of a building called “Akasaka Sacas” existing along the path and the word “Circus” included in the recognition result are acoustically similar to each other, and thus performs a correction to convert “Circus” into “Sacas.”

After that, in step S15, the response generation unit 16 generates a response based on the text “Is Akasaka Sacas around here?” The response generation unit 16 searches for web services or the like to acquire the location of Akasaka Sacas and offers the acquired location to the user.

Note that although the correction unit 12 performs the correction using the path information in this example, the path information may not be necessarily used. The correction unit 12 may use, for example, only a current location or a destination location to perform the correction. Note that the name of a landmark may be stored in advance in a voice recognition device or may be acquired from a mobile terminal or a car navigation device.

Next, an example of a case in which the category of the speech content is the “preference.”

When the category of the speech content is the “preference” (step S141C), the correction unit 12 acquires profile information on the user from the mobile terminal owned by the user via the user information acquisition unit 14 and corrects the recognition result using preference information included in the profile information (step S142C).

For example, it is assumed that the recognition result output from the voice recognition server 20 is “I was forced to eat pi-man by a friend” and the category of the speech content is determined to be the “preference” based on the word “pi-man.” In addition, it is assumed that information indicating that “pi-tan is unfavorite food” is included in the profile information. (Note that Japanese words “pi-man” and “pi-tan” mean bell pepper and century egg in English respectively.)

In this case, the correction unit 12 determines that the word “pi-tan” included in the profile information and the word “pi-man” included in the recognition result are acoustically similar to each other, and thus performs a correction to convert “pi-man” into “pi-tan.”

After that, in step S15, the response generation unit 16 generates a response based on the text “I was forced to eat pi-tan by a friend.” The response generation unit 16 generates, for example, a response “That's a food you do not like.” and offers the generated response to the user.

Next, an example of a case in which the category of the speech content is the “person.”

When the category of the speech content is the “person” (step S141D), the correction unit 12 acquires contact address information from the mobile terminal owned by the user via the user information acquisition unit 14, acquires a personal name included in the contact address information, and corrects the recognition result using the personal name (step S142D).

For example, it is assumed that the recognition result output from the voice recognition server 20 is “I have not recently seen Sakurazaka” and the category of the speech content is determined to be the “person” based on the word “have not seen.” In this case, the correction unit 12 determines that the surname “Kagurazaka” included in the contact address information and the word “Sakurazaka” included in the recognition result are acoustically similar to each other, and thus performs a correction to convert “Sakurazaka” into “Kagurazaka” (both Sakurazaka and Kagurazaka are possible as Japanese surnames, and Sakurazaka is a title of Japanese pop song).

After that, in step S15, the response generation unit 16 generates a response based on the text “I have not recently seen Kagurazaka.” The response generation unit 16 generates, for example, a response “How about calling Kagurazaka-san after a long time?” and offers the generated response to the user.

Note that it is assumed that the recognition result output from the voice recognition server 20 is “I have not recently heard Sakurazaka” and the category of the speech content is determined to be the “music” based on the word “have not heard.” When the word “Sakurazaka” included in the recognition result is the same as the word “Sakurazaka” included in the playback records of the music in this case, the correction unit 12 does not perform a correction.

Note that when the speech does not correspond to any of the categories, the processing of step S14 is omitted. That is, the processing of FIG. 3 is skipped.

As described above, the voice recognition device according to the embodiment classifies a user's speech content into a category and corrects a recognition result based on the category. Thus, the voice recognition device may improve accuracy in voice recognition. In addition, since the voice recognition device uses locally held user-specific information such as path information and contact address information to correct a recognition result, the voice recognition device may perform a correction more suitable for a user.

### Second Embodiment

A second embodiment is an embodiment in which the correction unit 12 and the response generation unit 16 of the first embodiment are provided in a separate server apparatus.

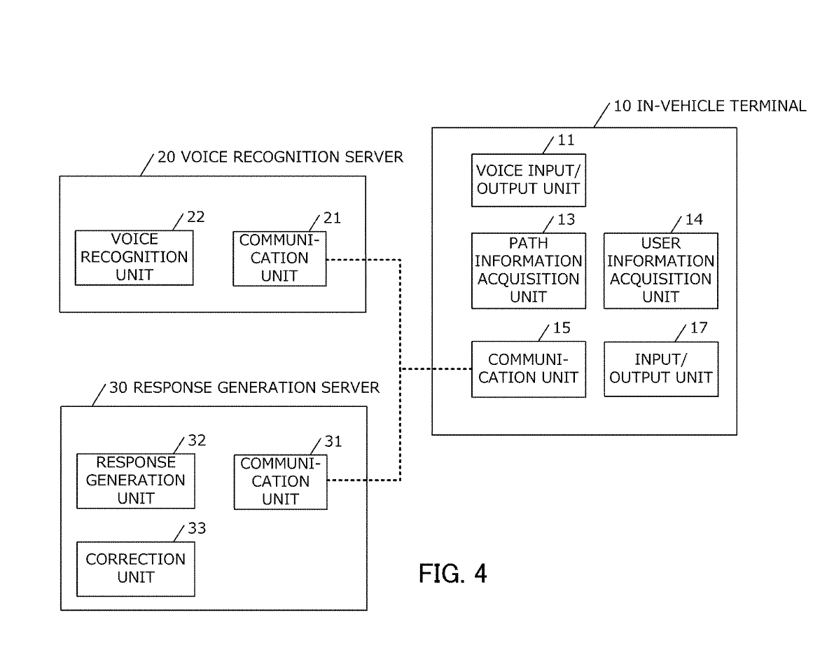

FIG. 4 is a system configuration diagram of a dialogue system according to the second embodiment. Note that function blocks having the same functions as those of the function blocks of the first embodiment will be denoted by the same symbols and their descriptions will be omitted.

In the second embodiment, a response generation server 30 serving as a server apparatus that generates a response text has a response generation unit 32 and a correction unit 33. The response generation unit 32 and the correction unit 33 correspond to the response generation unit 16 and the correction unit 12 of the first embodiment, respectively. Since the basic functions of the response generation unit 32 and the correction unit 33 are the same as those of the response generation unit 16 and the correction unit 12, their descriptions will be omitted.

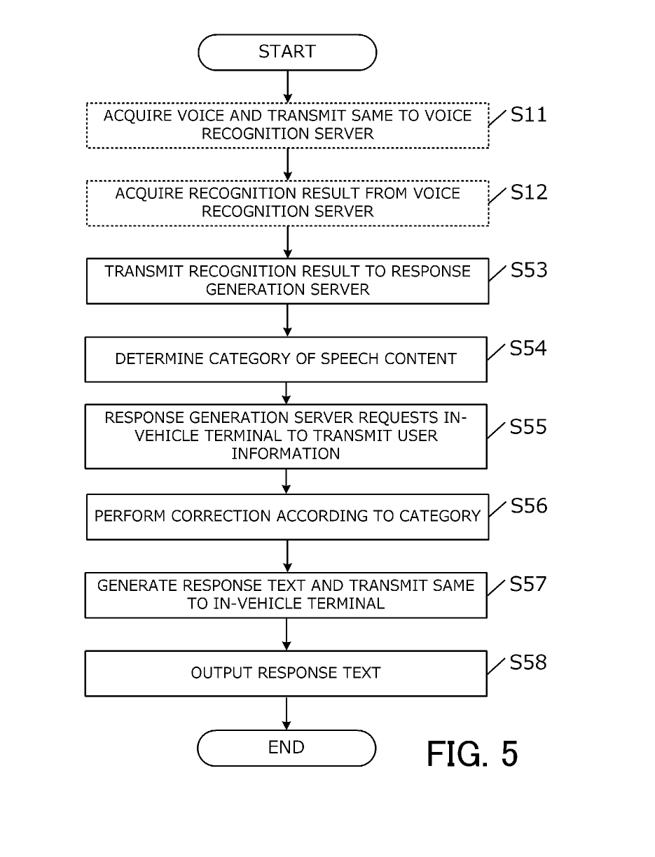

FIG. 5 is a processing flowchart diagram performed by the dialogue system according to the second embodiment. Since the processing of steps S11 and S12 is the same as that of the first embodiment, its description will be omitted.

In step S53, an in-vehicle terminal 10 transfers a recognition result acquired from the voice recognition server 20 to the response generation server 30. In step S54, the correction unit 33 determines the category of a speech content based on a method described above.

Next, in step S55, the correction unit 33 requests the in-vehicle terminal 10 to transmit user information corresponding to the determined category. Thus, path information acquired by a path information acquisition unit 13 or user information acquired by a user information acquisition unit 14 is transmitted to the response generation server 30.

Then, in step S56, the correction unit 12 corrects the text of the recognition result according to the determined category. Next, the response generation unit 32 generates a response text based on the corrected text and transmits the generated response text to the in-vehicle terminal 10 (step S57).

Finally, the response text is converted into voice in step S58 and offered to a user via a voice input/output unit 11.

### MODIFIED EXAMPLE

The above embodiments are given only as examples, and the present invention may be appropriately modified and carried out without departing from its spirit.

For example, user-specific information such as music playback records is used to perform a correction in the embodiments, but other information sources that are not user specific may be used so long as they are information sources corresponding to the classified categories. For example, when the category of a speech content is the music, web services to search for music titles or artist names may be used. Further, dictionaries dedicated to the categories may be acquired and used.

In addition, the four types of categories are shown in the embodiments, but categories other than these categories may be used. In addition, the information used by the correction unit 12 to perform a correction is not limited to the information described in the embodiments, and any information may be used so long as it serves as a dictionary corresponding to the classified categories. For example, the transmission and reception records of e-mails or SNS may be acquired from a mobile terminal owned by a user and used as a dictionary.

In addition, the voice recognition device according to the present invention is an in-vehicle terminal in the embodiments, but the present invention may be carried out using a mobile terminal. In this case, the path information acquisition unit 13 may acquire location information or path information from a GPS module provided in the mobile terminal or an application that is being activated. In addition, the user information acquisition unit 14 may acquire user information from the storage of the mobile terminal.

What is claimed is:

1. A voice recognition device comprising:
a voice acquisition unit that acquires voice given by a user;
a voice recognition unit that recognizes the acquired voice to acquire a voice recognition result;
a category classification unit that classifies a speech content of the user into a category, based on the voice recognition result;
an information acquisition unit that acquires a category dictionary including words corresponding to the classified category; and
a correction unit that corrects the voice recognition result, based on the category dictionary.

2. The voice recognition device according to claim 1, wherein
the category dictionary includes the words corresponding to the category and relevant to the user, and
the correction unit replaces a word included in the voice recognition result with one of the words included in the category dictionary when the word included in the category dictionary and the word included in the voice recognition result are similar to each other.

3. The voice recognition device according to claim 1, further comprising:
a location information acquisition unit that acquires location information, wherein
the information acquisition unit acquires information on a name of a landmark relevant to the location information as the category dictionary, and
the correction unit corrects the voice recognition result using the information on the name of the landmark when the speech content of the user is relevant to a location.

4. The voice recognition device according to claim 3, wherein
the information acquisition unit acquires the information on the name of the landmark existing near a location indicated by the location information.

5. The voice recognition device according to claim 3, further comprising:
a path acquisition unit that acquires information on a movement path of the user, wherein
the information acquisition unit acquires the information on the name of the landmark existing near the movement path of the user.

6. The voice recognition device according to claim 1, wherein
the information acquisition unit acquires information on a preference of the user as the category dictionary, and
the correction unit corrects the voice recognition result using the information on the preference of the user when the speech content of the user is relevant to the preference of the user.

7. The voice recognition device according to claim 1, wherein
the information acquisition unit acquires information on registered contact addresses from a mobile terminal owned by the user as the category dictionary, and
the correction unit corrects the voice recognition result using the information on the contact addresses when the speech content of the user is relevant to a person.

8. The voice recognition device according to claim 1, wherein
the voice recognition unit performs voice recognition via a voice recognition server.

9. A voice recognition method performed by a voice recognition device, the method comprising:
acquiring voice given by a user;
recognizing the acquired voice to acquire a voice recognition result;
classifying a speech content of the user into a category, based on the voice recognition result;
acquiring a category dictionary including words corresponding to the classified category; and
correcting the voice recognition result, based on the category dictionary.
